(19) United States
(12) Patent Application Publication
(10) Pub. No.: US 2023/0294584 A1
(43) Pub. Date: Sep. 21, 2023

(54) Vehicle Egress Assistance Device

(71) Applicant: Daniel Rusche, Sioux Falls, SD (US)

(72) Inventor: Daniel Rusche, Sioux Falls, SD (US)

(21) Appl. No.: 17/867,741

(22) Filed: Jul. 19, 2022

Related U.S. Application Data
(60) Provisional application No. 63/320,258, filed on Mar. 16, 2022.

(51) Int. Cl. B60N 3/02

(52) U.S. Cl. CPC B60N 3/023

(57) ABSTRACT

The present invention relates to a vehicle egress assistance device primarily comprised of a body, further comprised of a first end with a rubber tip and a second end with at least one handle. The device is designed to assist a user when entering (or exiting) a vehicle by removably attaching to the door latch of the vehicle. At least one rubber tip of the first end of the body is inserted into the latch, such that the device is retained within the latch. A user can then grasp the handle to lift themselves out of the vehicle using the device. The body may further be comprised of a hinge, such that the device can fold. In another embodiment, the handle is further comprised of a wrist strap to ensure the hand of the user does not slip from the device during use.

### CROSS-REFERENCE TO RELATED APPLICATION

The present application claims priority to, and the benefit of, U.S. Provisional Application No. 63/320,258 which was filed on Mar. 16, 2022, and is incorporated herein by reference in its entirety.

### FIELD OF THE INVENTION

The present invention relates generally to the field of mobility assistance devices. More specifically, the present invention relates to a vehicle egress assistance device primarily comprised of a body having a first end with a rubber tip and a second end with at least one handle. The device is designed to assist a user in entering or exiting a vehicle by removably attaching to the door latch of the vehicle. At least one rubber tip of the first end of the body is inserted into the latch, such that the device is retained within the latch. A user can then grasp the handle to lift themselves out of the vehicle using the device. The body may further be comprised of a hinge, such that the device can fold. In another embodiment, the handle is further comprised of a wrist strap to ensure the hand of the user does not slip from the device during use. Accordingly, the present disclosure makes specific reference thereto. Nonetheless, it is to be appreciated that aspects of the present invention are also equally applicable to other like applications, devices, and methods of manufacture.

### BACKGROUND

Individuals with limited physical strength and dexterity may have trouble exiting a vehicle. As a result, said individuals often require assistance from another person to help them successfully exit a vehicle. This can be extremely frustrating and embarrassing for the individual. As a result, an individual may choose to not ask for help exiting a vehicle, even if they require said help. If said individual tries to get out of a vehicle while using their hand to support their body weight on the vehicle rocker panel, they can easily slip, fall, and suffer serious injuries.

Therefore, there exists a long-felt need in the art for a device that aids a user with limited physical strength and dexterity when exiting a vehicle. Further, there exists a long-felt need in the art for a vehicle egress assistance device that can be attached to a vehicle to aid a user in exiting the vehicle. In addition, there exists a long-felt need in the art for a vehicle egress assistance device that can be attached to a vehicle to aid a user in exiting the vehicle, wherein the user can easily use the device without assistance from another individual. Furthermore, there exists a long-felt need in the art for a vehicle egress assistance device that can be attached to a vehicle to aid a user in exiting the vehicle, wherein the device can be easily stored within a vehicle.

The subject matter disclosed and claimed herein, in one embodiment thereof, comprises a vehicle egress assistance device. The device is primarily comprised of a body, further comprised of a first end with a rubber tip and a second end with at least one handle. The device is designed to assist a user when entering (or exiting) a vehicle. To do so, the device removably attaches to the door latch of the vehicle. At least one rubber tip of the first end of the body is inserted into the latch, such that the device is retained within the latch. A user can then grasp the handle to lift themselves out of the vehicle using the device. In one embodiment, the body is further comprised of a hinge, such that the device can fold. In another embodiment, the handle is further comprised of a wrist strap to ensure the hand of the user does not slip from the device during use.

In this manner, the vehicle egress assistance device of the present invention accomplishes all of the foregoing objectives and provides a device that aids a user with limited physical strength and dexterity when exiting a vehicle. Further, the device can be attached to a vehicle to aid a user in exiting the vehicle without assistance from another individual. Furthermore, the device ensures the user can exit the vehicle on their own in a safe manner.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a vehicle egress assistance device. The device is primarily comprised of a body, further comprised of a first end with a rubber tip and a second end with at least one handle. The device is designed to assist a user when entering (or exiting) a vehicle. To do so, the device removably attaches to the door latch of the vehicle. At least one rubber tip of the first end of the body is inserted into the latch, such that the device is retained within the latch. The tip is preferably manufactured from a rubber material that does not damage or scratch the latch and/or vehicle during use.

The second end is further comprised of at least one handle that is gripped by a user when the device is being used. The handle is comprised of a textured outer surface that may be comprised of a plurality of protrusions that aid a user in gripping the handle. In one embodiment, the handle also has at least one raised lip that further aids a user in gripping the handle and keepings their hand secured around the handle. The handle is also preferably manufactured from a rubber material that does not damage or scratch the latch and/or vehicle during use.

In one embodiment, the body is further comprised of at least one hinge that allows the body to fold in half for easy storage. When the device is in use, the hinge can be locked in position via at least one button. This ensures that the hinge will not collapse during use.

To further secure the device to a user during use, the handle may further be comprised of at least one wrist strap. The wrist strap may be made from an elastic and/or fabric material. The wrist wrap may also be further comprised of at least one fastener that allows the strap to tighten/loosen around the wrist of a user.

The device may also be comprised of a method of using the device. First, the user places the rubber tip into a latch of a vehicle. Optionally, the device can be unfolded and locked using the button in an embodiment of the device that has a hinge before the previous step is completed. Then, the wrist strap can be placed around the wrist of the user and secured using the fastener. Next, a user can grip the handle to lift themselves out of the seat of the vehicle. Then, the wrist strap can be removed from the wrist of the user. Afterward, the device can be maneuvered such that the rubber tip disengages the latch, and the device can be stowed within the vehicle until its next use.

Accordingly, the vehicle egress assistance device of the present invention is particularly advantageous as it provides a device that aids a user with limited physical strength and dexterity when exiting a vehicle. Further, the device can be attached to a vehicle to aid a user in exiting the vehicle without assistance from another individual. In this manner, the vehicle egress assistance device spares a user the embarrassment and frustration of asking for help to exit a vehicle. In addition, the device ensures the user can safely exit the vehicle.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a vehicle egress assistance device of the present invention in accordance with the disclosed architecture;

FIG. 2 illustrates a perspective view of one potential embodiment of a vehicle egress assistance device of the present invention while secured to a latch of a vehicle in accordance with the disclosed architecture;

FIG. 3 illustrates an enhanced perspective view of a handle of one potential embodiment of a vehicle egress assistance device of the present invention in accordance with the disclosed architecture;

FIG. 4 illustrates a perspective view of one potential embodiment of a vehicle egress assistance device of the present invention while secured to a latch of a vehicle and being used by a user in accordance with the disclosed architecture; and

FIG. 5 illustrates a flowchart view of one potential method of using potential embodiment of a vehicle egress assistance device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a device that aids a user with limited physical strength and dexterity when exiting a vehicle. Further, there exists a long-felt need in the art for a vehicle egress assistance device that can be attached to a vehicle to aid a user in exiting the vehicle. In addition, there exists a long-felt need in the art for a vehicle egress assistance device that can be attached to a vehicle to aid a user in exiting the vehicle, wherein the user can easily use the device without assistance from another individual. Furthermore, there exists a long-felt need in the art for a vehicle egress assistance device that can be attached to a vehicle to aid a user in exiting the vehicle, wherein the device can be easily stored within a vehicle.

The present invention, in one exemplary embodiment, is comprised of a vehicle egress assistance device primarily comprised of a body having a first end with a rubber tip and a second end with at least one handle. The device is designed to assist a user when entering (or exiting) a vehicle by removably attaching to a door latch of the vehicle. At least one rubber tip of the first end of the body is inserted into the latch, such that the device is retained within the latch. The tip is preferably manufactured from a rubber material that does not damage or scratch the latch and/or vehicle during use.

The second end is further comprised of at least one handle that is gripped by a user when the device is being used. The handle is comprised of a textured outer surface that may be comprised of a plurality of protrusions that aid a user in gripping the handle. In one embodiment, the handle also has at least one raised lip that further aids a user in gripping the handle and keepings their hand secured around the handle. The handle is also preferably manufactured from a rubber material that does not damage or scratch the latch and/or vehicle during use.

The body may also be comprised of at least one hinge that allows the body to fold in half for easy storage. When the device is in use, the hinge can be locked in position via at least one button. This ensures that the hinge will not collapse during use.

To further secure the device to a user during use, the handle may further be comprised of at least one wrist strap. The wrist strap may be made from an elastic and/or fabric material. The wrist wrap may also be further comprised of at least one fastener that allows the strap to tighten/loosen around the wrist of a user.

The device may also be comprised of a method of using the device. First, the user places the rubber tip into a latch of a vehicle. Optionally, the device can be unfolded and locked using the button in an embodiment of the device that has a hinge before the previous step is completed. Then, the wrist strap can be placed around the wrist of the user and secured using the fastener. Next, a user can grip the handle to lift themselves out of the seat of the vehicle. Then, the wrist strap can be removed from the wrist of the user. Afterward, the device can be maneuvered such that the rubber tip disengages the latch, and the device can be stowed within the vehicle until its next use.

Accordingly, the vehicle egress assistance device of the present invention is particularly advantageous as it provides a device that aids a user with limited physical strength and dexterity when exiting a vehicle. Further, the device can be attached to a vehicle to aid a user in exiting the vehicle without assistance from another individual. In this manner, the vehicle egress assistance device spares a user the embarrassment and frustration of asking for help to exit a vehicle. In addition, the device ensures the user can safely exit the vehicle.

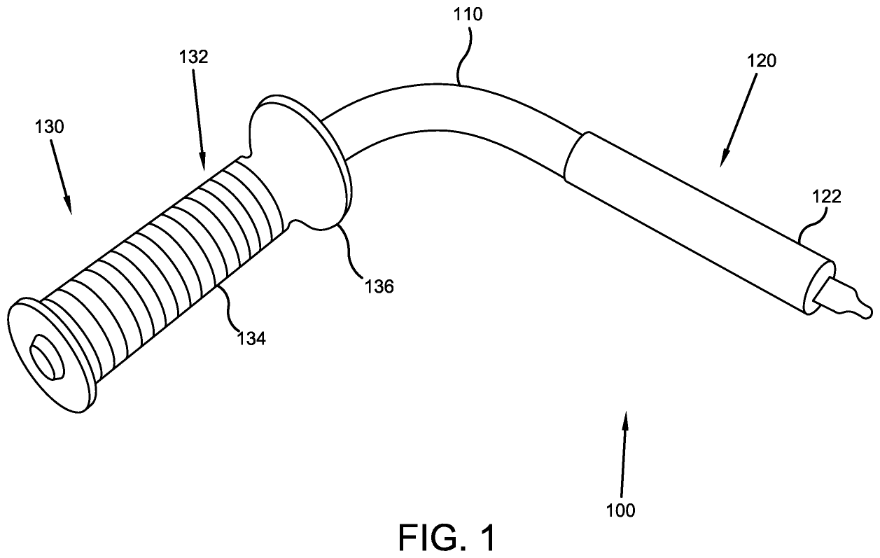

Referring initially to the drawings, FIG. 1 illustrates a perspective view of one potential embodiment of a vehicle egress assistance device 100 of the present invention in accordance with the disclosed architecture. The device 100 is primarily comprised of a body 110, further comprised of a first end 120 with a rubber tip 122 and a second end 130 with at least one handle 132. Unless otherwise specified herein, the device 100 is preferably manufactured from a durable metal material such as, but not limited to stainless steel, aluminum or a rigid plastic material such as, but not limited to: acrylic, polycarbonate, polyethylene, thermoplastic, acrylonitrile butadiene styrene, low-density polyethylene, medium density polyethylene, high-density polyethylene, polyethylene terephthalate, polyvinyl chloride, polystyrene, polylactic acid, acetal, nylon, fiberglass, recycled plastic, biodegradable plastic, etc. In the preferred embodiment, the body 110 is bent at a 35-degree angle and is generally L-shaped or generally V-shaped. The body 110 is also preferably tubular. However, in differing embodiments the body 110 may be any size, shape, and angle (between 0 and 180 degrees). In one embodiment, the body 110 may also be telescopic such that it can increase and decrease in length.

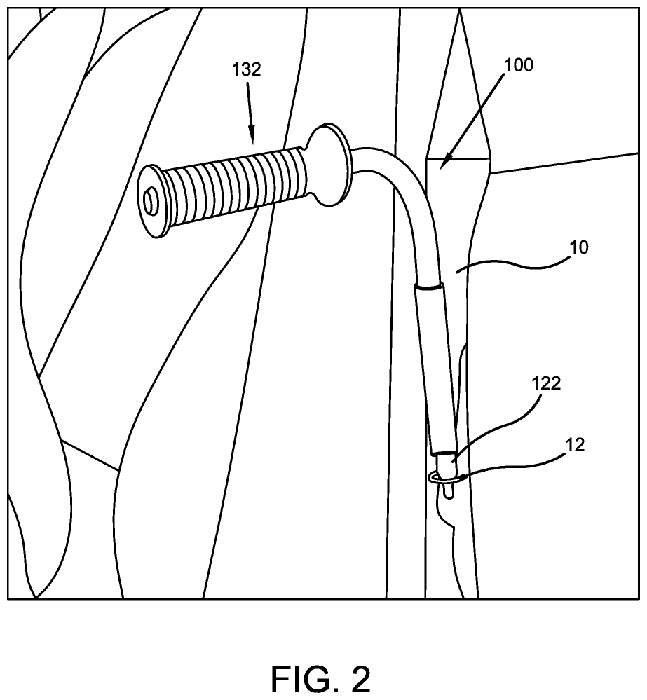

The device 100 is designed to assist a user when entering (or exiting) a vehicle 10. To do so, the device 100 removably attaches to the door latch 12 of the vehicle 10, as seen in FIG. 2. More specifically, at least one rubber tip 122 of the first end 120 is inserted into the latch 12, such that the device 100 is retained within the latch 12. In various embodiments, the rubber tip 122 may be a plurality of shapes such as, but not limited to: generally U-shaped, pointed, pointed with a rounded tip, generally L-shaped, etc., such that the tip 122 remains within and around the latch 12 when the device 100 is in use. The tip 122 is also preferably manufactured from a rubber material such as, but not limited to: Neoprene, silicone, nitrile, EPDM, Styrene-Butadiene, Butyl, natural, fluorosilicone, etc., that does not damage or scratch the latch 12 and/or vehicle 10 during use. The body 110 may also be coated in the same rubber material for the same reason. In one embodiment, the device 100 has a plurality of rubber tips 122 that each engage a specific portion of the latch 12, such that the device 100 is secured to the latch in all directions. In another embodiment, the tip 122 is magnetic to magnetically attach to the latch 12.

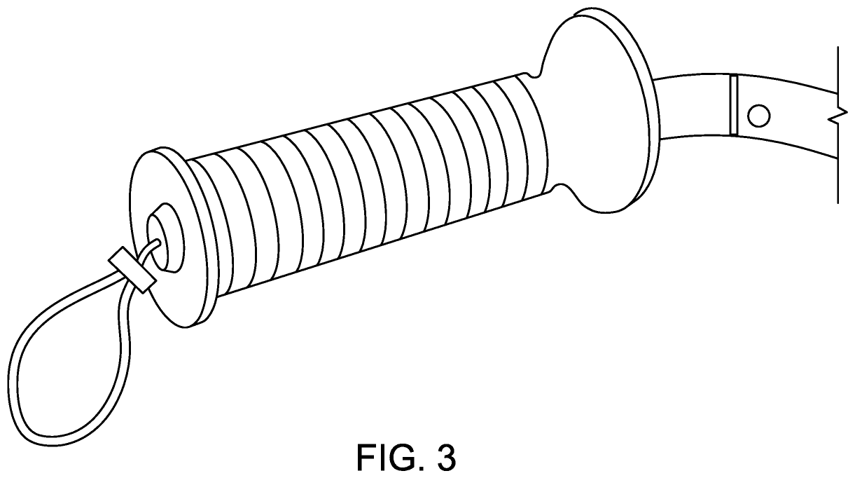

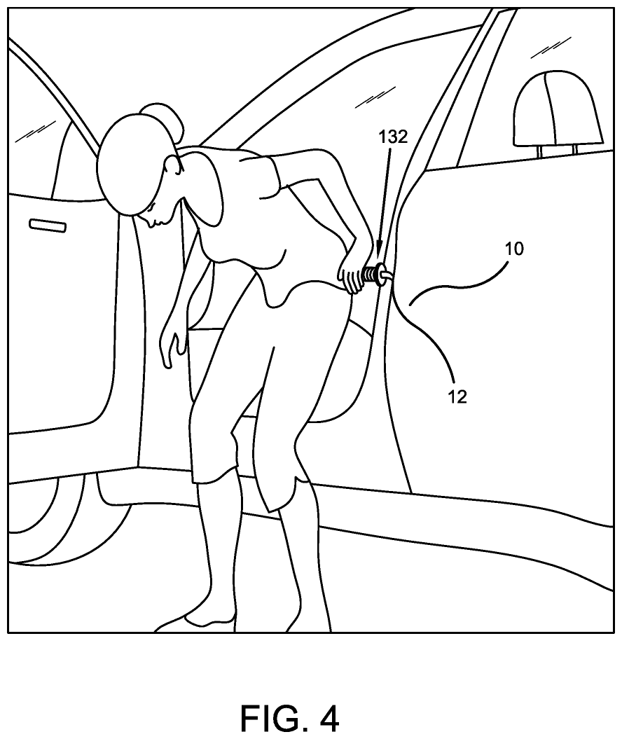

FIG. 3 illustrates an enhanced perspective view of a handle 132 of one potential embodiment of a vehicle egress assistance device of the present invention in accordance with the disclosed architecture. The second end 130 is further comprised of at least one handle 132. The handle 132 is gripped by a user when the device 100 is being used. In one embodiment, the handle 132 is generally cylindrical in shape. However, the handle 132 may be any shape in differing embodiments such as, but not limited to: spherical, rectangular, ring-shaped, etc., that facilitates the grasping of the handle 132 securely. The handle 132 is comprised of a textured, non-slip outer surface 134 that may be comprised of a plurality of protrusions that aid a user in gripping the handle 132, as seen in FIG. 4. In one embodiment, the handle 132 also has at least one raised lip 136 that further aids a user in gripping the handle 132 and keepings their hand secured around the handle 132. The handle 132 is also preferably manufactured from a rubber material such as, but not limited to: Neoprene, silicone, nitrile, EPDM, Styrene-Butadiene, Butyl, natural, fluorosilicone, etc., that does not damage or scratch the latch 12 and/or vehicle 10 during use. In one embodiment, the device 100 may have a plurality of handles 132 that may be arranged in a parallel or angled fashion. The handle 132 may be removably (for cleaning) or fixedly attached to the body in differing embodiments. The outer surface 134 of the handle 132 may further be comprised of a padded material.

In one embodiment, the body 110 is further comprised of at least one hinge 140. The hinge 140 may be any hinge type known in the art such as, but not limited to: an offset blind hinge, a knuckle hinge, a butt hinge, a rising butt hinge, a gravity pivot hinge, a ball bearing hinge, a barrel hinge, a concealed hinge, a knife hinge, a piano hinge, a strap hinge, a pivot hinge, a gas-piston hinge, an injection molded hinge, a locking hinge, etc. The hinge 140 allows the body 110 to fold in half for easy storage. When the device 100 is in use, the hinge 140 can be locked in position via at least one button 150 that ensures the hinge 140 will not collapse during use.

To further secure the device 100 to a user during use, the handle 132 may further be comprised of at least one wrist strap 160. The wrist strap 160 is preferably looped and can attach around the wrist of the user. The wrist strap 160 may be made from an elastic and/or fabric material and may also be further comprised of at least one fastener 162. The fastener 162 may allow the strap 160 to tighten/loosen around the wrist of a user. In differing embodiments, the fastener 162 may be any fastener type known in the art such as, but not limited to: hook and loop, snap button, magnet, buckle, slide buckle, etc.

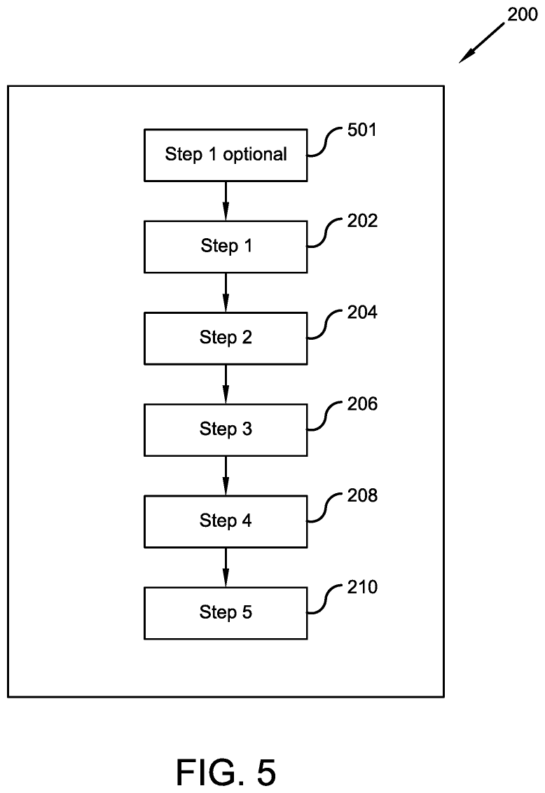

FIG. 5 illustrates a flowchart view of one potential method 200 of using potential embodiment of a vehicle egress assistance device 100 of the present invention in accordance with the disclosed architecture. The device 100 may also be comprised of a method 200 of using the device 100. First, the user places the rubber tip 122 into a latch 12 of a vehicle 10 [Step 202]. Optionally, the device 100 can be unfolded and locked using the button 150 in an embodiment of the device 100 that has a hinge 140 before Step 202 is completed [Step 201]. Then, the wrist strap 160 can be placed around the wrist of the user and secured using the fastener 162 [Step 204]. Next, a user can grip the handle 132 to lift themselves out from a seat of the vehicle 10, as seen in FIG. 4 [Step 206]. Next, the wrist strap 160 can be removed from the wrist of the user [Step 208]. Then, the device 100 can be maneuvered such that the rubber tip 122 disengages the latch 12 and the device 100 can be stowed within the vehicle 10 until its next use [Step 210].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “vehicle egress assistance device” and “device” are interchangeable and refer to the vehicle egress assistance device 100 of the present invention.

Notwithstanding the foregoing, the vehicle egress assistance device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the vehicle egress assistance device 100 as shown in the FIGS. are for illustrative purposes only, and that many other sizes and shapes of the vehicle egress assistance device 100 are well within the scope of the present disclosure. Although the dimensions of the vehicle egress assistance device 100 are important design parameters for user convenience, the vehicle egress assistance device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A vehicle egress assistance device comprising:
a body comprised of a first end and a second end:
at least one rubber tip positioned on the first end; and
a handle positioned on the second end.

2. The vehicle egress assistance device of claim 1, wherein the body is L-shaped.

3. The vehicle egress assistance device of claim 1, wherein the first end is angled at a 35-degree angle relative to the second end.

4. The vehicle egress assistance device of claim 1, wherein the rubber tip is rounded.

5. A vehicle egress assistance device comprising:
a body comprised of a first end and a second end:
at least one rubber tip positioned on the first end;
a handle positioned on the second end;
a hinge; and
a wrist strap.

6. The vehicle egress assistance device of claim 5, wherein the body is a V-shaped body.

7. The vehicle egress assistance device of claim 5, wherein the body is coated in a rubber material.

8. The vehicle egress assistance device of claim 5, wherein the rubber tip is magnetic.

9. The vehicle egress assistance device of claim 5, wherein the handle is further comprised of a raised lip.

10. The vehicle egress assistance device of claim 5, wherein the handle is further comprised of a textured, non-slip outer surface.

11. The vehicle egress assistance device of claim 5 further comprising a second handle.

12. The vehicle egress assistance device of claim 11, wherein the handle and the second handle are parallel.

13. The vehicle egress assistance device of claim 5 further comprised of a button.

14. The vehicle egress assistance device of claim 13, wherein the button locks the hinge.

15. The vehicle egress assistance device of claim 5, wherein the wrist strap is further comprised of a fastener.

16. The vehicle egress assistance device of claim 15, wherein the fastener is a hook and loop fastener, a snap button faster, a magnet fastener, a buckle fastener or a slide buckle fastener.

17. The vehicle egress assistance device of claim 5, wherein the rubber tip is a U-shaped tip, a pointed tip, a rounded tip or a L-shaped tip.

18. A method of using a vehicle egress assistance device, the method comprising the steps of:
placing a rubber tip of the vehicle egress assistance device into a latch of a vehicle;
placing a wrist strap of the vehicle egress assistance device around a wrist of a user;
securing the wrist strap around the wrist using a fastener of the wrist strap;
gripping a handle of the vehicle egress assistance device in order to lift the user from a seat of the vehicle;
removing the wrist strap from the wrist;
disengaging the rubber tip from the latch; and
stowing the vehicle egress assistance device until needed.

19. The method of claim 18, wherein the vehicle egress assistance device is further comprised of a hinge.

20. The method of claim 19 further comprised of the steps of unfolding and locking the hinge of the vehicle egress assistance device using a button.
